(19) United States
(12) Patent Application Publication
(10) Pub. No.: US 2013/0125831 A1
(43) Pub. Date: May 23, 2013

(54) HORSE TRAINING DEVICE

(71) Applicant: Kevin Wheeler, Proctor, MT (US)

(72) Inventor: Kevin Wheeler, Proctor, MT (US)

(21) Appl. No.: 13/300,635

(22) Filed: Nov. 20, 2011

(51) Int. Cl. A01K 15/02; A01K 15/00; A01K 15/04

(52) U.S. Cl. 119/720; 119/816; 119/859

(57) ABSTRACT

The present invention is a horse training device that is secured to and removably worn on a cannon bone CB of each front leg of a horse to train and prevent the horse from pawing includes an elongated planar base, a hook and loop fastener to removably secure the device to the horse, a pair of stimulus prongs that is disposed on the elongated planar base that are in communication with a pendulum switch disposed within the elongated planar base that deliver an electric shock to the horse and a remote control that includes a power indicator light, a power activation button and a pair of power settings that include a first sliding bar, a second sliding bar and a plurality of predetermined measuring indicia that are relative measurement indicia or quantitative measurement indicia.

### TECHNICAL FIELD & BACKGROUND

Individuals who own horses are continuously searching for humane methods to eliminate the horse's pawing habit. Conventional techniques include a shock to the horse's neck which may confuse the horse as the shock may not target the specific area desired.

The present invention generally relates to a training device. More specifically, the invention is a horse training device.

It is an object of the invention to provide a horse training device that is utilized and secured to a horse's cannon bone.

It is an object of the invention to provide a horse training device that better instructs a horse of an undesired activity such as pawing that is trying to be prevented.

It is an object of the invention to provide a horse training device that utilizes a momentary electric shock to prevent a horse from performing an undesirable activity such as pawing.

What is really needed is a horse training device that is utilized and secured to a horse's cannon bone that better instructs a horse of an undesired activity such as pawing that is trying to be prevented and that utilizes a momentary electric shock to prevent a horse from performing an undesirable activity such as pawing.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates an environmental perspective view of a horse training device, in accordance with one embodiment of the present invention.

FIG. 1B illustrates a front perspective view of a remote control of a horse training device, in accordance with one embodiment of the present invention.

FIG. 1C illustrates an overhead perspective view of a horse training device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

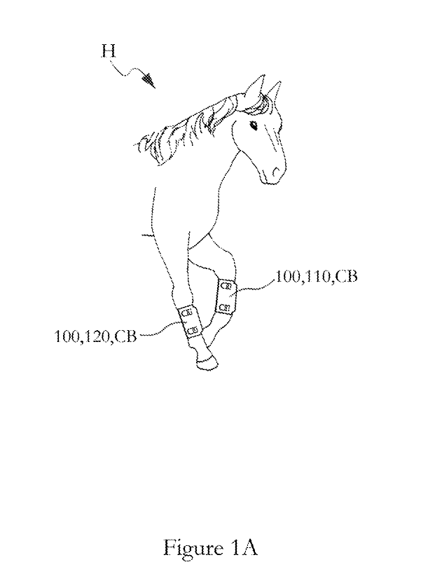

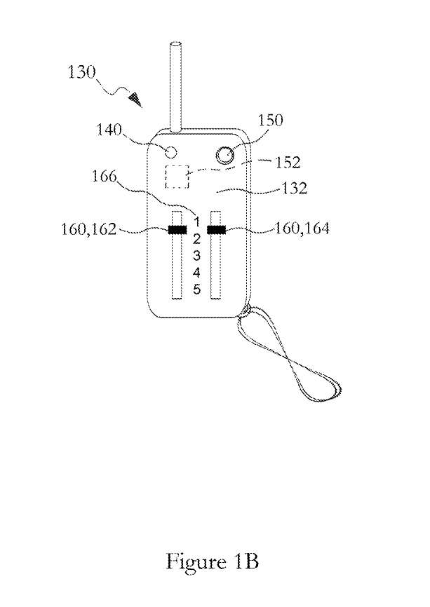

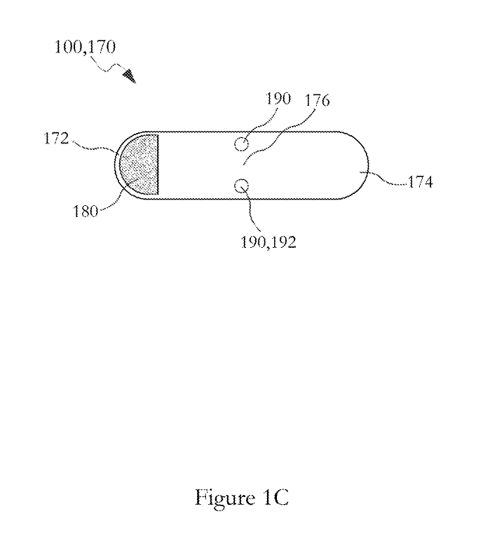

FIG. 1A illustrates an environmental perspective view of a horse training device 100, in accordance with one embodiment of the present invention. The horse training device 100 is typically secured to and worn on the cannon bone CB of a horse H to train and prevent the horse H from pawing. However, the horse training device 100 can be secured and worn on any suitable portion of a horse H or other suitable animal such as a mule to prevent the mule from pawing. Because the horse training device 100 is disposed on the cannon bone CB or lower leg portion of a horse's leg, the horse H associates the relatively small electrical shock with pawing and is shocked when the horse H begins to paw, thereby physically encouraging the horse H not to paw. Typically a horse training device 100 is placed on each cannon bone CB of the front two legs of the horse H so that the electric shock can be applied to the horse H when the horse H begins pawing with either front leg, however the horse training device 100 can be applied and secured to any suitable portion of the horse H. The horse training device 100 can be a first horse training device 110 and a second horse training device 120. The first horse training device 110 is colored differently than the second horse training device 120 to assist in distinguishing between the two horse training devices 110,120.

FIG. 1B illustrates a front perspective view of a remote control 130 in communication with a horse training device 100, in accordance with one embodiment of the present invention.

The remote control 130 has a front facing 132 and includes a power indicator light 140, a power activation button 150 and a pair of power settings 160. The power indicator light 140 is disposed on the front facing 132 of the remote control 130 and indicates if the remote control 130 is activated. If the power indicator light 140 is illuminated, then the remote control 130 is activated and if the indicator light 140 is not illuminated then the remote control 130 is not activated. The power activation button 150 is disposed on the front facing 132 of the remote control 130 and can be depressed to activate the power activation button 150. The power activation button 150 receives power from a 9 volt battery 152 that is housed within the remote control 130. Once activated, the power activation button 150 can be depressed again to deactivate and shut-off the power activation button 150. The pair of power settings 160 include a first sliding bar 162, a second sliding bar 164 and a plurality of predetermined measuring indicia 166 disposed between the first sliding bar 162 and the second sliding bar 164. The first sliding bar 162 is in communication with the first horse training device 110 and controls the strength of the electric shock provided to the first horse training device 110 which can be slid to increase or decrease the strength of the provided electric shock according to the predetermined measuring indicia 166. The predetermined measuring indicia 166 can be any type of relative indicia such as a number sequence 1, 2, 3 etc. or actual measurement indicia such as 1 volt, 2 volts, 3 volts etc. Similarly, the second sliding bar 164 is in communication with the second horse training device 120 and controls the strength of the electric shock provided to the second horse training device 120 which can be slid to increase or decrease the strength of the provided electric shock according to the predetermined measuring indicia 166.

FIG. 1C illustrates an overhead perspective view of a horse training device 100, in accordance with one embodiment of the present invention. The horse training device 100 can serve as the first horse training device 110 or the second horse training device 120.

The horse training device 100 includes an elongated planar base 170, a hook and loop fastener 180 and a pair of stimulus prongs 190. The elongated planar base 170 has a proximal rounded end 172, a distal rounded end 174 and a middle portion 176 and as previously described and illustrated in FIG. 1A and its description is typically secured to and worn on the cannon bone CB of a horse H to train and prevent the horse H from pawing, although the horse training device 100 can be worn on other suitable areas of a horse as well. The hook and loop fastener 180 is disposed on the proximal rounded end 172 of the elongated planar base 170 and removably secures the horse training device 100 around the horse's cannon bone CB. The hook and loop fastener 180 is a VELCRO™ type of hook and loop fastener 180, although other suitable types of hook and loop fasteners may also be utilized with the horse training device 100. The pair of stimulus prongs 190 is disposed on the middle portion 176 of the elongated planar base 170. The stimulus prongs 190 are in contact with the cannon bone CB of the horse and are in communication with and controlled by the pair of power settings 160 previously described in FIG. 1C. The stimulus prongs 190 are in communication with a pendulum switch 192 disposed within the elongated planar base 170 that is in communication with the pair of power settings 160. The pendulum switch 192 activates the stimulus prongs 190 automatically when the horse H begins to paw and delivers an electric shock to the horse H. The horse training device 100 is made of nylon but can be made of other suitable material as well. The horse training device 100 is approximately 8 to 10 inches in width, which is a suitable dimension range to cover the horse's cannon bone CB sufficiently for a plurality of different sized horses H to prevent the horse H from pawing.

Comprised of color coded shock straps afforded stimulus prongs designed to be removably secured to a horse's leg at the horse's cannon bone, the horse training device is a suitable alternative to current similar available training devices. Easy to use, the horse training device is simply attached with a hook and loop type VELCRO™ strap to each front leg of the horse and adjusts the independent intensity of either device utilizing the provided remote control. When the horse paws, the pendulum switch in the strap delivers a momentary shock stimulus to the horse's leg, thereby correcting the behavior. The horse training device is useful and humane, and can be frequently utilized by individuals who own show horses, training facilities, horse riding clubs and the like. The horse training device features rechargeable nylon straps devised to deliver a momentary shock stimulus to the cannon bone of a pawing horse in order to successfully and humanely correct the undesired pawing behavior. The remote control includes separate controls for each horse training device, and is designed to work along with the pendulum switch within the straps to regulate the stimulus which is powered by a 9 volt battery.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A horse training device, comprising;
an elongated planar base with a proximal rounded end, a distal rounded end and a middle portion;
a hook and loop fastener to removably secure said device to a horse that is disposed on said proximal rounded end of said elongated planar base;
a pair of stimulus prongs that is disposed on said middle portion of said elongated planar base that are in communication with a pendulum switch disposed within said elongated planar base that deliver an electric shock to said horse; and
a remote control with a front facing that includes a power indicator light, a power activation button and a pair of power settings disposed on said front facing and a 9 volt battery that is housed within said remote control.

2. The device according to claim 1, wherein said pendulum switch is in communication with said power settings that controls said stimulus prongs and activates said stimulus prongs automatically when said horse begins to paw.

3. The device according to claim 1, wherein said power settings include a first sliding bar, a second sliding bar and a plurality of predetermined measuring indicia disposed between said first sliding bar and said second sliding bar.

4. The device according to claim 3, wherein said first sliding bar is in communication with a first horse training device and controls a first electric shock provided to said first horse training device.

5. The device according to claim 3, wherein said second sliding bar is in communication with a second horse training device and controls a second electric shock provided to said second horse training device.

6. The device according to claim 1, wherein said device is secured to and removably worn on a cannon bone CB of each front leg of said horse to train and prevent said horse from pawing.

7. A horse training device, comprising:
an elongated planar base with a proximal rounded end, a distal rounded end and a middle portion;
a hook and loop fastener to removably secure said device to said horse that is disposed on said proximal rounded end of said elongated planar base;
a pair of stimulus prongs that is disposed on said middle portion of said elongated planar base that are in communication with a pendulum switch disposed within said elongated planar base that deliver an electric shock to said horse; and
a remote control with a front facing that includes a power indicator light, a power activation button and a pair of power settings disposed on said front facing, wherein said power settings include a first sliding bar, a second sliding bar and a plurality of predetermined measuring indicia disposed between said first sliding bar and said second sliding bar.

8. The device according to claim 7, wherein said pendulum switch is in communication with said power settings that controls said stimulus prongs and activates said stimulus prongs automatically when said horse begins to paw.

9. The device according to claim 7, wherein said first sliding bar is in communication with a first horse training device and controls a first electric shock provided to said first horse training device.

10. The device according to claim 7, wherein said second sliding bar is in communication with a second horse training device and controls a second electric shock provided to said second horse training device.

11. The device according to claim 7, wherein said predetermined measuring indicia are relative measurement indicia.

12. The device according to claim 7, wherein said predetermined measuring indicia are quantitative measurement indicia.

13. The device according to claim 7, wherein said horse training device that is secured to and removably worn on a cannon bone CB of each front leg of a horse to train and prevent said horse from pawing

14. A nylon horse training device that is secured to and removably worn on a cannon bone CB of each front leg of a horse to train and prevent said horse from pawing, comprising:
an elongated planar base with a proximal rounded end, a distal rounded end and a middle portion;
a hook and loop fastener to removably secure said device to said horse that is disposed on said proximal rounded end of said elongated planar base;
a pair of stimulus prongs that is disposed on said middle portion of said elongated planar base that are in communication with a pendulum switch disposed within said elongated planar base that deliver an electric shock to said horse; and
a remote control with a front facing that includes a power indicator light, a power activation button and a pair of power settings that include a first sliding bar, a second sliding bar and a plurality of predetermined measuring indicia disposed between said first sliding bar and said second sliding bar disposed on said front facing, wherein said predetermined measuring indicia are relative measurement indicia or quantitative measurement indicia.

15. The device according to claim 14, wherein said pendulum switch is in communication with said power settings that controls said stimulus prongs and activates said stimulus prongs automatically when said horse begins to paw.

16. The device according to claim 14, wherein said power settings include a first sliding bar, a second sliding bar and a plurality of predetermined measuring indicia disposed between said first sliding bar and said second sliding bar.

17. The device according to claim 14, wherein said first sliding bar is in communication with a first horse training device and controls a first electric shock provided to said first horse training device.

18. The device according to claim 14, wherein said second sliding bar is in communication with a second horse training device and controls a second electric shock provided to said second horse training device.

19. The device according to claim 14, wherein said device is used by a mule.

20. The device according to claim 14, wherein said horse training device is approximately 8 to 10 inches in width.
